(19) United States
(12) Patent Application Publication
(10) Pub. No.: US 2015/0018190 A1
(43) Pub. Date: Jan. 15, 2015

(54) Solid bowl screw-type centrifuge

(71) Applicants: Heinz Solscheid, Lohmar (DE); Robert Wagenbauer, Wurmsham (DE)

(72) Inventors: Heinz Solscheid, Lohmar (DE); Robert Wagenbauer, Wurmsham (DE)

(73) Assignee: HILLER GMBH, Vilsbiburg (DE)

(21) Appl. No.: 14/378,623

(22) PCT Filed: Mar. 21, 2013
(86) PCT No.: PCT/EP2013/055956

§ 371 Date: Aug. 13, 2014

(30) Foreign Application Priority Data
Mar. 22, 2012 (DE) 10 2012 102 478.2

(51) Int. Cl. B04B 1/20

(52) U.S. Cl. CPC B04B 1/20
USPC 494/4

(57) ABSTRACT

A solid bowl screw-type centrifuge used to continually separate a composition of substances with different densities includes a rotor drum, rotatable about a horizontal axis, with a cylindrical drum section and a conical drum section, and a conveying screw mounted therein, rotating about the same axis, with a helical vane attached to a hollow shaft for transporting the heavy phase to discharge openings in the conical drum section. On a front wall closing the cylindrical drum section, at least one outflow opening for the light phase is provided with a device for setting the fluid level. The device for setting the fluid level is composed of a control element with a system for braking or accelerating the fluid particles of the light phase, which is rotatively driven at a speed different to the drum speed and releases a flow through an annular clearance to the inner wall of the drum.

### FIELD OF THE INVENTION

The invention relates to a solid bowl screw centrifuge for continuous separation of a mixture of flowable substances having different densities.

### BACKGROUND OF THE INVENTION

In screw centrifuges of the existing art, for example in accordance with DE 39 21 327, the device for adjusting the liquid level comprises a weir that can be mechanically displaced during operation. The mixture to be separated is charged via a static inflow tube into a charging chamber integrated into the screw body and from there into the working space of the centrifuge, and is subjected to a corresponding centrifugal acceleration due to the drum rotation speed. In the working space of the centrifuge, the solid material, usually of higher density, settles against the inner wall of the drum and is conveyed by the conveyor screw to openings at the end of the conical drum and spun out. The clarified centrate (the light phase) flows in the screw flight oppositely to the solids transport direction and leaves the centrifuge through the weir opening.

The weir known from DE 39 21 327 is displaced in a radial direction via an axially shiftable ring and a deflection member in order to adjust the liquid level.

Another adjustment capability is described and depicted in EP 702 599 B1, in which the throttle disk of the weir is displaced axially so that the orifice can be modified relative to a stationary throttle disk.

DE 103 36 350 A1 describes and depicts a solid bowl screw centrifuge in which a scraper disk, which is preceded by a throttle disk, is arranged nonrotatably on the inflow tube that is stationary during operation. The two disks can be axially displaced by means of an electrical drive system. Alternatively, the throttle disk can be embodied as an element rotating with the drum.

### SUMMARY OF THE INVENTION

The object on which the invention is based, in the context of a screw centrifuge of the type described hereinafter, is that of simplifying the design of the device for setting the liquid level while retaining the possibility of level adjustment during operation.

This object is achieved according to the present invention in that the device for adjusting the liquid level is made up of a control element having means for decelerating or accelerating the liquid particles of the light phase, which element is rotationally driven at a rotation speed different from the drum rotation speed and leaves open a flowthrough annular gap with respect to the drum inner wall.

This manner of achieving the object has the considerable advantage, as compared with the existing art, that adjusting the liquid level does not require a weir having a mechanical positioning mechanism, since a control element whose rotation speed is modifiable is instead provided.

As a refinement of the invention, the control element is embodied as an immersion disk whose surface discontinuities can decelerate or accelerate the liquid particles. Ribs axially protruding from the immersion disk are possible as surface discontinuities, but in addition also slits or holes in the immersion disk, projections, or roughened surface areas. These can be provided on one side or on both sides of the immersion disk.

An alternative possibility is to embody the control element as a vane rotor.

The control element can be fastened on the hollow shaft of the conveyor screw, so that the rotation speed of the control element is simultaneously linked to a change in the screw rotation speed.

In a variant of the invention, the control element can be rotatably mounted on a hollow stub shaft of the rotor drum and can be connected to a dedicated rotational drive system in the form of a motor. Upon a deceleration of the control element, the rotational drive system acts as output drive for a generator.

### BRIEF DESCRIPTION OF THE DRAWINGS

Further features and advantages of the invention are evident from the claims and from the description below of exemplifying embodiments that are depicted in the drawings, in which:

FIG. 1 is a schematic partly sectioned view of a screw centrifuge in a first exemplifying embodiment of the invention,

FIG. 2 shows two communicating tubes having a liquid filling,

FIG. 3 shows the U-shaped tube of FIG. 2 having two liquids of different densities,

FIG. 4 shows the centrifuge depicted in FIG. 1 with a drive motor for the control element,

FIG. 5 shows a variant of FIG. 4,

FIG. 6 shows a further variant of FIG. 4,

FIG. 7 shows a variant of FIG. 6 as a three-phase centrifuge,

FIG. 8 shows a further modified embodiment for the principle of FIG. 6,

FIG. 9 is an enlarged depiction of a portion of FIG. 8,

FIG. 10 shows a variant of FIG. 8, and

FIG. 11 depicts a detail of FIG. 10.

### DETAILED DESCRIPTION OF EMBODIMENTS OF THE INVENTION

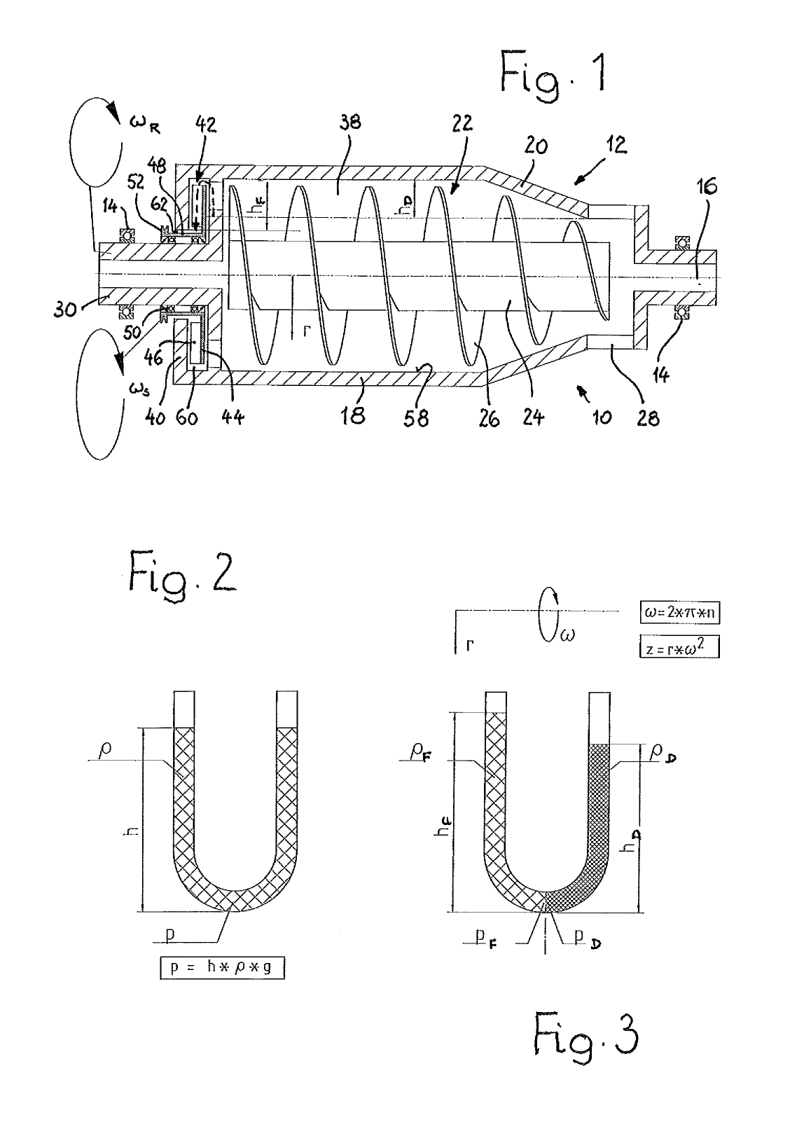

FIG. 1 schematically shows a first exemplifying embodiment of a solid bowl screw centrifuge 10 in accordance with the invention. The latter is made up, in known fashion, of a rotor drum 12 that is supported at both ends in radial bearings 14 and is rotatable by means of a drive system (not shown) around a horizontal axis 16. The rotor drum has a cylindrical drum segment 18 and a conical drum segment 20.

A conveyor screw 22, having a rotation speed differing from the drum rotation speed, is mounted in rotor drum 12 rotatably around axis 16. The rotational drive system necessary for this is likewise not depicted. Conveyor screw 22 is made up of a hollow shaft 24 to which screw flights 26 are attached for transporting the heavy phase to discharge openings 28 in conical drum segment 20.

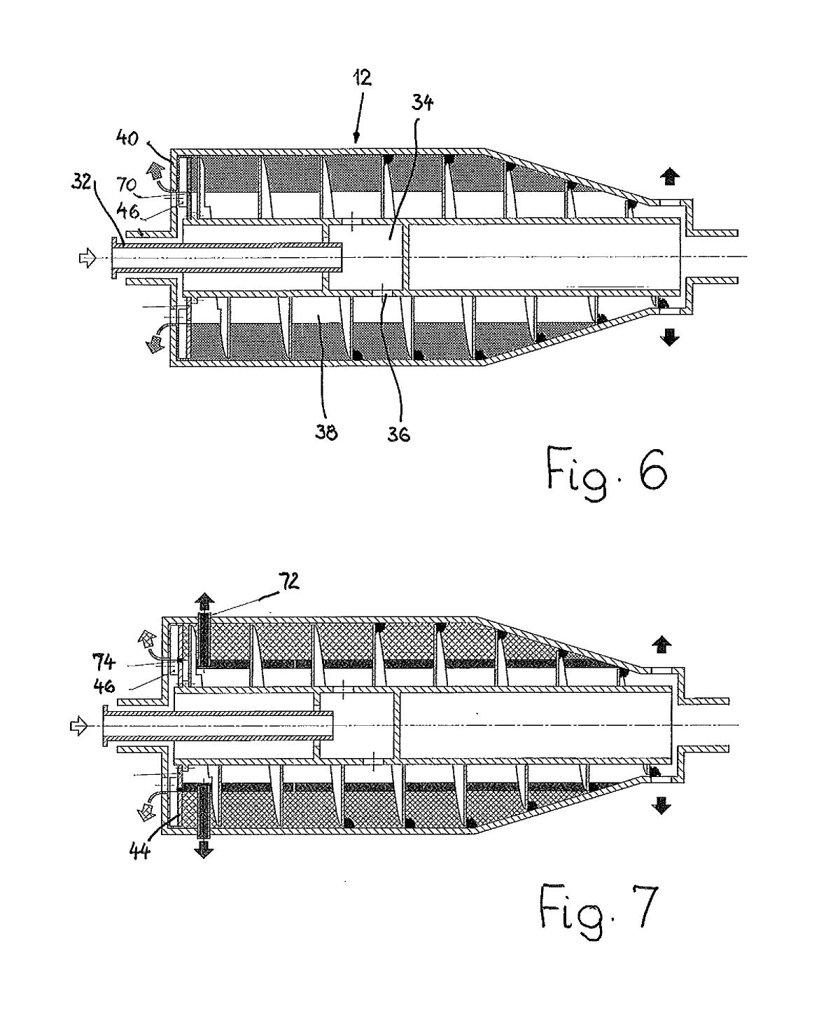

An inflow tube 32 not depicted in FIG. 1 (see FIG. 6) for the mixture to be separated (charge suspension) leads through the left (in FIG. 1) hollow stub shaft 30 of rotor drum 12 axially into a charging chamber 34 embodied in hollow shaft 24, from which chamber charging openings 36 lead into working space 38 of screw flights 26.

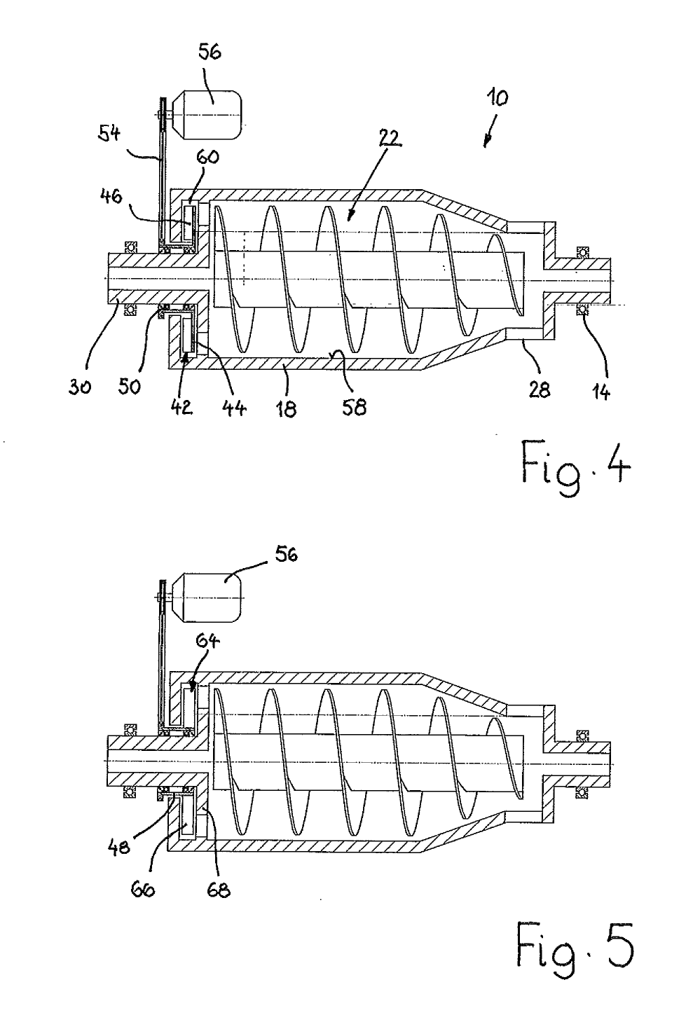

When the centrifuge is in operation, screw flights 26 deliver the high-density phase (solids), which assumes a level hp with respect to the drum inner wall, into conical drum segment 20, from which it is delivered via discharge opening 28. The liquid, light phase (centrate), having a level h_{F}, flows in the opposite direction to end wall 40 that terminates cylindrical drum segment 18, control element 42 being arranged according to the present invention before said wall. In the example of FIG. 1, said element is made up of a radially oriented immersion disk 44 from which axial ribs 46 protrude toward end wall 40. Immersion disk 44 is fastened here to a cylindrical ring 48 that is mounted on hollow stub shaft 30 rotatably via two ball bearings 50. At its end projecting out of drum 12, ring 48 has a belt pulley 52 for belt connection 54 to an electric motor 56 (see FIG. 4).

The pressure in the region of control element 42 behaves like that in a U-shaped tube, in which the centrate particles firstly flow radially with respect to drum inner wall 58, and then flow outward through annular gap 60 and overflow 62 in end wall 40.

FIG. 2 shows a U-shaped tube, both of whose tubes are filled with a liquid of level h. The pressure existing at the vertex of the U-shaped tube is ρ=h·ρ·g, where ρ=density of the liquid and g=acceleration of gravity.

FIG. 3 shows a corresponding model of a rotating U-shaped tube in the region of control element 42 of FIG. 1. The expression describing the pressures P_{Z} of centrate F (liquid phase) and P_{D} of the slurry (heavy phase) at the vertex is:

P_{F}=P_{D},

such that, where z=centrifugal acceleration:

P_{F}=h_{F}·ρ_{F}·z

P_{D}=h_{D}·ρ_{D}·z

The differing angular speeds of rotor drum ω_{R} and of control element ω_{S} are indicated in FIG. 1. The angular speed of the rotor drum determines the angular speed ω_{F} of the liquid phase:

ω_{R}=ω_{F}.

The angular speed ω_{S} of control element 42, embodied as an immersion disk 44 with or without ribs 46, is approximately equal to the angular speed ω_{D} of the slurry (heavy phase), but different from ω_{F} of the centrate:

ω_{S}≈ω_{D}≠ω_{F}.

Three different cases will now be considered. In the first case, immersion disk 44 of control element 42 is assumed to be embodied without ribs 46, for example as depicted in FIG. 11. Here a centrate particle retains the circumferential speed acquired at drum inner wall 58. This means that the angular speed ω_{OF} of the centrate particle must increase with as the diameter becomes smaller. The centrate therefore moves faster than the surrounding drum wall. The increase in angular speed causes an increase in the centrifugal acceleration z and thus in the liquid pressure in gap 60 between immersion disk 44 and drum inner wall 58. In this gap, the pressure behaves as it does in the U-shaped tube of FIG. 2, i.e. the liquid columns on either side of immersion disk 44 generate the same pressure. Because the liquids in front of and behind immersion disk 44 have the same density ρ but are subject to different centrifugal accelerations, pressure equilibrium can be achieved only by a rise in the level of the liquid column in working space 38 of the centrifuge. In an extreme case, this can result in an undesirable overflow of liquid through solids discharge 28.

The second case corresponds to the sketches shown in FIGS. 6, 7, 8, and 9, in which immersion disk 44 is fastened on hollow shaft 24 of conveyor screw 22 and is equipped with ribs 46 on its side facing toward end wall 40. A centrate particle at first has the circumferential speed acquired at drum inner wall 58. As the diameter becomes smaller, the centrate particle is forced to assume the circumferential speed corresponding to the radius and to the screw rotation speed. (In this instance the screw rotation speed differs only insignificantly from the drum rotation speed.) This means that as the diameter becomes smaller, the angular speed of the centrate particle remains unchanged. The centrate has approximately the same angular speed as the surrounding drum wall. As a result, there is no undesired level influence on working space 38 of the centrifuge because of the U-shaped tube effect (liquid density and centrifugal acceleration are the same).

The third case corresponds to what is depicted in FIG. 4, in which control element 42, having immersion disk 44 equipped with ribs 46, can be driven (or decelerated by a generator) relative to the drum rotation speed by a motor 56. Alternatively, as sketched in FIG. 5, control element 42 can be embodied as a rotor 64 having substantially radially oriented vanes 66. The deceleration instance will be explained below; the drive instance is correspondingly the opposite.

The centrate particle enters gap 60 between immersion disk 44 and end wall 40 at the circumferential speed acquired at drum inner wall 58. In the region of ribs 46 or vanes 66, the centrate particle is forced to assume approximately the rotation speed of immersion disk 44 or vanes 66. The circumferential speed of the centrate particle is decelerated in accordance with the rotation speed of the immersion disk or vanes, and in accordance with the diameter in question. The deceleration energy is converted into electrical energy in the generator. The centrifugal acceleration acting on the centrate particle decreases in accordance with the lower circumferential speed. Equilibrium conditions in gap 60 between immersion disk 44 and drum inner wall 58 become established due to a decrease in the liquid level in working space 38 of the centrifuge. When vanes 66 are used, a separating wall 68 with respect to working space 38 of the centrifuge is necessary.

In the example of FIG. 6, as already mentioned, immersion disk 44 of control element 42 is fastened directly on hollow shaft 24 of conveyor screw 22, the rotational drive system of which is known and not depicted further. Between ribs 46, immersion disk 44 has outflow openings 70 for discharge of the liquid phase.

FIG. 7 shows a three-phase version of the centrifuge having radially adjustable overflow tubes 72, distributed over the circumference, for discharge of a light liquid. Outflow openings 70 for discharging a heavy liquid can be closed off by screws 74. In the conical drum segment 20, solids are delivered through discharge opening 28.

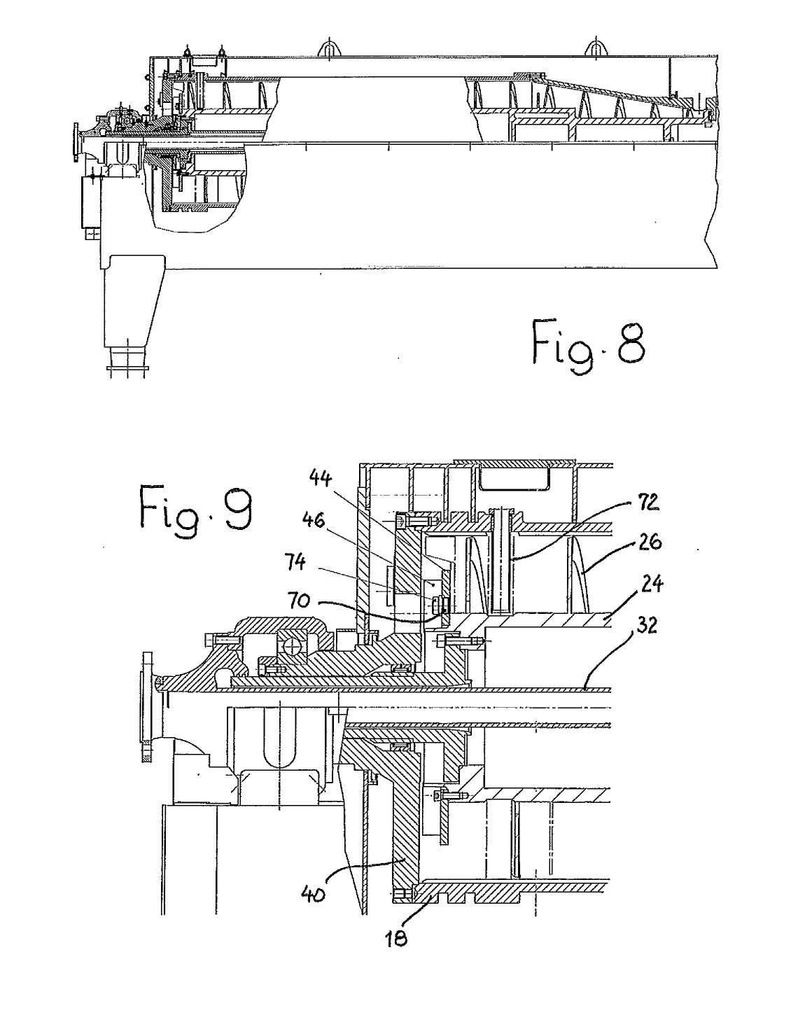

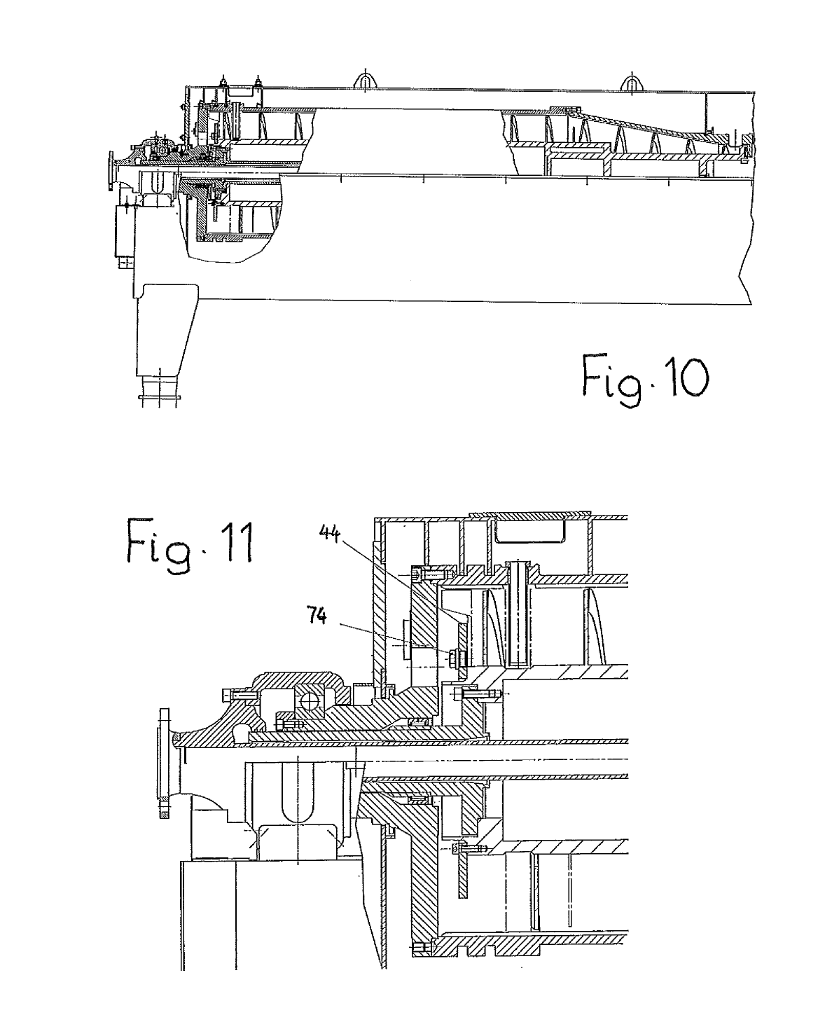

The embodiment depicted in FIGS. 8 and 9 is comparable to the version of FIG. 7, in which immersion disk 44 is fastened on hollow shaft 24 of conveyor screw 22 and is equipped with ribs 46. One of the screws 74 for closing off outflow opening 70 in immersion disk 44 is clearly evident in FIG. 9.

Lastly, FIGS. 10 and 11 once again show a version having an immersion disk 44 with no ribs. Here the means for decelerating or accelerating the liquid particles can comprise different surface discontinuities, e.g. roughened areas or protrusions.

Influencing the liquid level during operation of the centrifuge yields the following capabilities:
1. The centrifuge can be adapted to changes in inflow volumes or to a fluctuating solids concentration.
2. The dryness of the solids, and the clarity of the centrate, can be influenced.
3. The transport behavior of the solids can be adapted to specific product properties.

1. A solid bowl screw centrifuge for continuous separation of a mixture of flowable substances having different densities, comprising:
a rotor drum (12) rotatable around a horizontal axis (16) and having a cylindrical drum segment (18) and a conical drum segment (20); and
a conveyor screw (22), mounted in the rotor drum and rotating around the horizontal axis (16), having screw flights (26), attached to a hollow shaft (24), for transporting a heavy phase to discharge openings (28) in the conical drum segment (20), while at an end wall (40), closing off the cylindrical drum segment (18), at least one outflow opening (62) for a light phase is provided with a device for adjusting the liquid level,
wherein the device for adjusting the liquid level includes a control element (42) having a system decelerating or accelerating liquid particles of the light phase, the control element being rotationally driven at a rotation speed different from drum rotation speed and leaving open a flowthrough annular gap (60) with respect to a drum inner wall (58).

2. The solid bowl screw centrifuge according to claim 1, wherein the control element (42) is arranged, in a flow direction of the light phase, before the end wall (40) closing off the cylindrical drum segment (18).

3. The solid bowl screw centrifuge according to claim 1, wherein the control element (42) is configured as an immersion disk (44).

4. The solid bowl screw centrifuge according to claim 1, wherein the control element (42) is configured as a rotor (64) having vanes (66).

5. The solid bowl screw centrifuge according to claim 1, wherein the system decelerating or accelerating the liquid particles is provided as surface discontinuities provided on the control element (42).

6. The solid bowl screw centrifuge according to claim 5, wherein the system is configured as ribs (46) protruding axially from the control element (42).

7. The solid bowl screw centrifuge according to claim 1, wherein the control element (42) is fastened on the hollow shaft (24) of the conveyor screw (22).

8. The solid bowl screw centrifuge according to claim 1, wherein the control element (42) is rotatably mounted on a hollow stub shaft (30) of the rotor drum (12) and is connected to a dedicated rotational drive system (56) or rotational output drive.

9. The solid bowl screw centrifuge according to claim 5, wherein the surface discontinuities include at least one outflow opening (70).

10. The solid bowl screw centrifuge according to claim 9, wherein the outflow opening (70) is closable.

11. The solid bowl screw centrifuge according to claim 1, wherein at least one radially inwardly protruding overflow tube (72) for three-phase separation is arranged on the rotor drum (12) before the control element (42) in the flow direction of the light phase.
